(19) United States
(12) Patent Application Publication
(10) Pub. No.: US 2011/0228442 A1
(43) Pub. Date: Sep. 22, 2011

(54) CAPACITOR HAVING HIGH TEMPERATURE STABILITY, HIGH DIELECTRIC CONSTANT, LOW DIELECTRIC LOSS, AND LOW LEAKAGE CURRENT

(75) Inventors: Shihai Zhang, State College, PA (US); Chen Zou, State College, PA (US); Xin Zhou, State College, PA (US); Qiming Zhang, State College, PA (US)

(73) Assignee: Strategic Polymer Sciences, Inc., State College, PA (US)

(21) Appl. No.: 13/049,423

(22) Filed: Mar. 16, 2011

Related U.S. Application Data
(60) Provisional application No. 61/314,355, filed on Mar. 16, 2010.

(51) Int. Cl. H01G 4/06

(52) U.S. Cl. 361/311

(57) ABSTRACT

Examples of the present invention include high electric energy density polymer film capacitors with high dielectric constant, low dielectric dissipation tangent, and low leakage current in a broad temperature range. More particularly, examples include a polymer film capacitor in which the dielectric layer comprise a copolymer of a first monomer (such as tetrafluoroethylene) and a second polar monomer. The second monomer component may be selected from vinylidene fluoride, trifluoroethylene or their mixtures, and optionally other monomers may be included to adjust the mechanical performance. The capacitors can be made by winding metallized films, plain films with metal foils, or hybrid construction where the films comprise the new compositions. The capacitors can be used in DC bus capacitors and energy storage capacitors in pulsed power systems.

### REFERENCE TO RELATED APPLICATION

This application claims priority from U.S. Provisional Application Ser. No. 61/314,355, filed Mar. 16, 2010, the entire content of which is incorporated herein by reference.

### GRANT REFERENCE

This invention was made with government support under Grant Nos. DE-EE0004540 and DE-SC0004191 from the United States Department of Energy. The government has certain rights in the invention.

### FIELD OF THE INVENTION

The present invention relates to high performance polymer film capacitors.

### BACKGROUND OF THE INVENTION

The commercial and consumer requirements for compact and more reliable electric power and electronic systems such as hybrid electric vehicles and defibrillators have grown substantially over the past decade. As a result, high electric energy and power density capacitor has grown to become a major enabling technology.

A desired capacitor component may have small size, high energy efficiency, and high temperature operating capability. To achieve small size, the capacitor dielectric layer may have a high dielectric constant (K), thin dielectric film thickness, and high dielectric breakdown strength.

Conventional polymeric dielectrics have low dielectric constants that are usually lower than 3.2. However, they have very high breakdown field (>600 MV/m) and they have a relatively high energy density and capacitance. Biaxially oriented polypropylene (PP) has a high breakdown field (˜600 MV/m) and a low dielectric constant of 2.2. However, its operation temperature is limited to 105° C. due to its low melting temperature Tₘ of ˜170° C. Other dielectric polymers may offer higher operation temperature and slightly higher dielectric constant than PP. These include polycarbonate (PC, K=3.1), polyethylene terephthalate (PET, K=3.2), Polyethylene naphthalate (PEN, K=3.2), and polyphenylene sulfide (PPS, K=3.1). However, their dielectric constant is still very low.

Polyvinylidene fluoride (PVDF) based polar fluoropolymers have high dielectric constant (K>8) and high dielectric breakdown strength (>600 MV/m), therefore they provide high energy density and high capacitance density. Unfortunately, these polar fluoropolymers have high dielectric loss tan δ and low temperature stability. For example, PVDF has tan δ of ˜1.3% at 25° C. and 1 kHz, it increases to ˜4.1% at 120° C. Furthermore, it has a melting temperature about 170° C. The high tan δ and low Tₘ limit the operation temperature of PVDF to below 85° C.

Polytetrafluoroethylene (PTFE) is a fluoropolymer with high temperature stability and low dielectric loss tangent. However, PTFE cannot be produced into thin film with uniform thickness since it cannot be extruded into film and it does not have organic solvent. Furthermore, PTFE has a very low dielectric constant of 2.0. The large thickness and low dielectric constant will make a capacitor with very low capacitance density.

Table I below compares the dielectric performance and temperature range of several commercial film capacitors.

TABLE I
Dielectric properties of polymeric dielectric materials (T_{g}:
glass transition temperature, and Tₘ: melting temperature)

| | | | | | Operation |
|---|---|---|---|---|---|
| | | | T_{g} | Tₘ | Temperature |
| | K | tan δ | (° C.) | (° C.) | (° C.) |
| Polypropylene (PP) | 2.2 | 0.02% | | 170 | 105 |
| Polycarbonate (PC) | 3.1 | 0.2% | 149 | 267 | 125 |
| Polyethylene terephthalate | 3.2 | 0.2% | 78 | 245 | 125 |
| (PET) | | | | | |
| Polyethylene naphthalate | 3.2 | 0.5% | 120 | 280 | 140 |
| (PEN) | | | | | |
| Poly(ethylene-co- | 2.7 | 0.08% | | 265 | N/A |
| tetrafluoroethylene) | | | | | |
| (ETFE) | | | | | |
| Polytetrafluoroethylene | 2.0 | 0.02% | | >300 | 200 |
| (PTFE) | | | | | |
| Poly(phenylene sulfide) | 3.1 | 0.06% | 88 | 280 | 150 |
| (PPS) | | | | | |
| Polyetherimide | 3.2 | 0.35% | 217 | | 175 |
| (Ultem ® 1000) | | | | | |
| Poly(vinylidene fluoride) | 10 | 2% | | 170 | 85 |
| (PVDF) | | | | | |

Therefore, there is a great demand for capacitors that can offer high temperature stability, low leakage current, low dielectric loss, and high dielectric constant.

U.S. Pat. No. 5,087,679 disclosed copolymers of chlorotrifluoroethylene, trifluoroethylene, and vinylidene fluoride with dielectric constant higher than 40 at room temperature. However, their tan δ is above 5% and their melting temperature is lower than 140° C.

U.S. Pat. No. 4,543,294 disclosed a copolymer of tetrafluoroethylene, ethylene, and vinylidene fluoride. However, the tan δ increases dramatically at high temperature

U.S. Pat. No. 6,787,238, U.S. Pat. No. 6,355,749, U.S. Pat. No. 7,078,101, and US patent application 20070167590 also disclosed copolymers of trifluoroethylene, vinylidene fluoride and a third bulky monomer with dielectric constant higher than 40 at room temperature. However, their tan δ is above 5% at room temperature and their melting temperature is lower than 140° C. Their tan δ increases to over 10% or even 20% at higher temperature.

### SUMMARY OF THE INVENTION

Examples of the present invention include an improved charge or energy storage device having a novel copolymer dielectric film as the dielectric layer. The device can be used for storing, and/or controlling, and/or manipulating electric charge and/or electric energy. A specific example of such a device is a film capacitor.

An example device includes a dielectric layer (such as a polymer film) including a copolymer which has at least two different components, such as different monomer components copolymerized to obtain the copolymer. A first component may be tetrafluoroethylene (TFE), the presence of which allows remarkable high temperature stability, and excellent electrical properties such as high electric resistivity and low dielectric loss tangent to be obtained. A second component may be an unsaturated halogenated (e.g. perfluorovinyl) monomer with a large dipole moment, for example above 1.0 Debye. Examples include vinylidene fluoride (VDF), trifluoroethylene (TrFE), vinyl fluoride (VF), 1-chloro-1-fluoroetheylene (CFE), or other monomers. The second components have strong dipole moment and provide high dielectric constant.

Examples of the present invention also include such novel copolymers for use as a component of a dielectric layer, for example as used in a device for storing, and/or controlling, and/or manipulating electric charge and/or electric energy.

Apparatus according to examples of the invention include devices for storing, and/or controlling, and/or manipulating charge and/or electric energy. Example devices include polymer film capacitors. An example device includes a dielectric layer comprising a copolymer including a first component and a second component. An example device includes a dielectric layer comprising a copolymer including tetrafluoroethylene (TFE) as the first component, the copolymer containing from 50% to 90% by weight of the first component.

In example copolymers, the first component (such as tetrafluoroethylene) is present by at least 50% by weight, such as greater than 62% by weight, such as greater than 65% by weight, for example at least 70% by weight. For example, the first component may contribute to a copolymer as 50% to 90% by weight, 62% to 90% by weight, 65% to 90% by weight, or more particularly 70% to 90% by weight.

The second component, such as a halogenated ethylene having an appreciably greater dipole moment than tetrafluoroethylene, may be present in a copolymer from 5% to 50% by weight, more particularly as 10% to 50% by weight. In some examples, the second component is present as 5% to 20% by weight. The second component may include one or more unsaturated halovinyl monomers, such as fluorovinyl monomers, preferably having a monomer dipole moment larger than 1 Debye. The second component may include one or more monomers selected from the group consisting of vinylidene fluoride (VDF), trifluoroethylene (TrFE), 1-chloro-1-fluoroethylene (CFE), and vinyl fluoride.

A copolymer may include an optional third component, including monomers larger in size (bulkier) than vinylidene fluoride (VDF), which may increase the flexibility and melt-processing capability of the copolymer. An example copolymer may include approximately equal to or less than 20% by weight of a third component. For example, a copolymer may include a third component as 1% to 20% by weight. The third component may comprise one or more monomers selected from the group consisting of hexafluoropropylene (HFP), chlorotrifluoroethylene (CTFE), and unsaturated perfluorovinyl ethers with the formula CF₂═CF—OR_{f}, where R_{f} is a perfluoroalkyl having 1 to 8 carbon atoms, or some combination thereof. Other monomers may also be used to achieve the same objective. Such third components can be included to destroy the regularity of the crystalline phase in the copolymer, and introduce mechanical flexibility and the capability to produce the dielectric layer using melt-based processes.

Example copolymers include poly(tetrafluoroethylene-co-vinylidene fluoride), poly(tetrafluoroethylene-co-vinylidene fluoride-co-hexafluoropropylene), poly(tetrafluoroethylene-co-vinylidene fluoride-co-chlorotrifluoroethylene), poly(tetrafluoroethylene-co-trifluoroethylene), poly(tetrafluoroethylene-co-vinylidene fluoride-co-CF₂CF—O—CₙF₂ₙ₊₁) where 1≧n≧8, poly(tetrafluoroethylene-co-vinylidene fluoride-co-hexafluoropropyl ene-co-2-propoxypropylvinyl ether), poly(tetrafluoroethylene-co-vinylidene fluoride-co-hexafluoropropylene-co-perfluoro-2-methoxy-ethylvinyl ether).

The inclusion of tetrafluoroethylene monomers into e.g. PVDF-based copolymer is counter-intuitive for energy storage applications, as tetrafluoroethylene has a very low dipole moment. Polymers and copolymers of fluorinated vinyl monomers such as VDF are associated with a very high dipole moment, and with a high energy density capability in thin film capacitors. The inclusion of tetrafluoroethylene monomers, particularly at concentrations above 50% by weight, in a copolymer appears to undermine the advantages of the highly polar component. However, the combination of VDF and other polar monomers with a non-polar component such as tetrafluoroethylene was found to give remarkably improved electrical properties.

An example copolymer is poly(tetrafluoroethylene-co-vinylidene fluoride-co-hexafluoropropylene), the first component being tetrafluoroethylene present from 65% to 90% by weight, the second component being VDF present from 5% to 20% by weight, and the third component being HFP present from 1% to 20% by weight. As one example, a copolymer may be poly(tetrafluoroethylene-co-vinylidene fluoride-co-hexafluoropropylene), where the content of tetrafluoroethylene is approximately equal to or greater than 70% by weight, for example 70%-90% by weight, and the melting temperature of the copolymer is greater than 200° C.

Another example copolymer is poly(tetrafluoroethylene-co-vinylidene fluoride-co-hexafluoropropylene), tetrafluoroethylene (the first component) being present between 70% to 80% by weight, VDF (the second component) being present from 5% to 20% by weight, and HFP (the third component) being present from 1% to 20% by weight.

A copolymer may additionally include organic and/or inorganic fillers, or other additives to improve physical or chemical properties.

Copolymers according to examples of the present invention have excellent electrical properties, such as one or more of the following attributes. Coolymers described herein allow capacitor operation with a dielectric loss tangent (tan δ) lower than 2% at 1 kHz from −25° C. to 125° C. The copolymer may have a dielectric constant above 4.0 at 1 kHz at temperatures from −25° C. to 85° C. Examples of the present invention provide a copolymer having a volume resistivity above 10¹⁵ Ω·cm at 25° C., and above 10¹³ Ω·cm at 125° C. The dielectric layer may have a charge-discharge efficiency higher than 90% at 400 MV/m electric field. Examples of the present invention allow a dielectric layer to have a DC dielectric breakdown strength above 500 MV/m at 25° C.

A novel polymer dielectric layer has dielectric constant above 4.0, and dielectric loss below 2% at temperatures from −25° C. to 125° C. Preferably, the novel polymer dielectric layer has a melting temperature (Tₘ) above 160° C., and further has an electric volume resistivity above 10¹⁵ Ω·cm at 25° C.

Copolymers according to examples of the present invention allow higher temperature operation than conventional polymer dielectric based high energy capacitive devices. In some examples, the polymer has a melting temperature approximately equal to or greater than 160° C., and in some cases the melting temperature may be approximately equal to or greater than 200° C.

In some examples, a copolymer film can be crosslinked, for example using irradiation crosslinking, ionic crosslinking, free radical initiated crosslinking, crosslinking through functional groups, or other crosslinking approach. A copolymer may be crosslinked to form a thermosetting material. In some examples, the copolymer is a semicrystalline polymer.

A dielectric layer may be a polymer film, formed from or otherwise including a copolymer such as those as described herein. A polymer film may be a solvent cast film, a melt extruded film, or a melt extrusion blown film. The polymer film may be stretched in one or more directions, and may have a stretching ratio (in one or more directions) from 100% to 900% of the original length in each direction. A stretching ratio of 100% is defined as the film is stretched to be 100% longer than its original length. A polymer film can be stretched in one or more directions with a stretching ratio higher than 300% of the original length in each stretched direction. Examples of the present invention allow the Young's modulus of an unstretched polymer film to be higher than 400 MPa, and this can be further increased by stretching or other physical or chemical processing. In some examples, the dielectric layer, such as a polymer film, is coated with another material to form a multilayer structure.

Example dielectric layers include capacitor films, though the invention is not limited to capacitor films. A capacitor film can be obtained directly from solvent cast. More preferably, a capacitor film can also be obtained by melt extrusion through a film die. A capacitor film can be stretched in either one direction or two directions. A capacitor film can also be obtained by extrusion blowing or double-bubble blowing, with or without further stretching.

Examples of the invention include a capacitor comprising a dielectric film including a copolymer as described herein, the dielectric film having first and second electrodes deposited on opposed sides of the film. A capacitor may have a planar, wound, multilayer, or other structure.

Examples of the present invention include polymer film capacitors in which the dielectric layer is a polymer film including a copolymer as described herein. A film capacitor may include one or more metallized dielectric layers, alternating dielectric layers and metal foils, or a hybrid metallized film and foil construction. Examples of the present invention further include a pulsed power apparatus including a polymer film capacitor as described herein, and power inverters and power converters including a DC bus capacitor, the DC bus capacitor being a thin film capacitor as described herein. Examples of the present invention also include a medical defibrillator including a thin film polymer capacitor as described herein, power management electronics (for example, in solar and wind energy), power inverters in electric vehicles, and dielectrics in microelectronic devices for storing, controlling, and manipulation of electric charge, electric energy, and electric power with high efficiency.

High energy density polymer film capacitors are described that can be used in a broad range of power electronics and electric power systems such as these used in defibrillators, in electric vehicles, and in electric weapons.

Examples of the present invention also include a field effect transistor having a polymer film as the gate dielectric, the polymer film including a copolymer such as described herein. Examples of the present invention include other apparatus having a dielectric layer subject to electrical fields, where improved electrical properties such as those described herein are desired.

Apparatus, such as a thin film capacitor or other apparatus including a thin film capacitor as described herein, can be operated above 105° C. due to the impressive thermal stability of the inventive copolymers. In other examples, apparatus is operable above 125° C. This is significant for several applications, such as use in electric or hybrid vehicles and/or proximate a combustion engine, for example for energy conversion applications, and the like.

Examples of the present invention also include electrocaloric device such as a heat pump or thermoelectric cooling device, the comprising a dielectric layer including a copolymer as described herein. An electrocaloric device generates temperature and entropy changes upon applying or removing an electric field applied to the copolymer dielectric layer, based on the electrocaloric effect. Improved electrocaloric properties are obtained, compared with conventional devices.

### BRIEF DESCRIPTION OF THE DRAWINGS

Further objects, features and advantages of the present invention will be understood by reference to the drawings and detailed description that follow.

FIG. 1 shows the dielectric constant K at 1 kHz of PVDF, P(VDF-HFP) and P(VDF-TrFE-CFE).

FIG. 2 shows the dielectric loss tangent tan δ at 1 kHz of PVDF, P(VDF-HFP) and P(VDF-TrFE-CFE).

FIG. 3 schematically illustrates the chemical structures and orientation of C—F dipoles in several fluorinated monomers.

FIG. 4 presents the first heating DSC curves of five different capacitor films.

FIG. 5 compares the dielectric constant of copolymers A, B, and C at 1 kHz.

FIG. 6 compares the dielectric loss tan δ of blown films A, B, and C at 1 kHz.

FIG. 7 shows the dielectric constant and tan δ of uniaxially stretched film C.

FIG. 8 compares the DC dielectric breakdown strength of uniaxially copolymers A, B, C at 26° C. and 16% relative humidity.

FIG. 9 compares the DC dielectric breakdown strength of uniaxially stretched copolymer film C at different temperatures.

FIG. 10 shows the DC dielectric breakdown strength of blown film, uniaxially, and biaxially orientated copolymer film C at room temperature.

FIG. 11 summarizes the discharged energy density of the uniaxially stretched capacitor films A, B, C, PVDF, and PP.

FIG. 12 compares the charge-discharge efficiency of different capacitor films at 25° C.

FIG. 13 compares the electric volume resistivity of P(TFE-VDF-HFP) copolymers, PP and PVDF at different temperatures measured at 100 MV/m.

FIG. 14 presents the polarization charge density at 500 MV/m of PP, PVDF, and P(TFE-VDF-HFP) compositions A, B, and C.

FIGS. 15A-B present the stress versus strain curves of composition P(TFE-VDF-HFP) composition C at (A) machine direction and (B) transverse direction.

### DETAILED DESCRIPTION OF THE PREFERRED EMBODIMENTS

Examples of the present invention include improved charge or energy storage devices including a novel copolymer dielectric film as the dielectric layer, used for storing, and/or controlling, and/or manipulating electric charge and/or electric energy.

Example devices have a dielectric layer (such as a polymer film) including a copolymer which has a first component and a second component. A first component may be tetrafluoroethylene (TFE). A second component may be an unsaturated halogenated monomer with a large dipole moment, for example a dipole moment greater than 1.0 Debye. Examples include vinylidene fluoride (VDF), trifluoroethylene (TrFE), vinyl fluoride (VF), 1-chloro-1-fluoroetheylene (CFE), and other monomers.

Examples of the present invention include high performance polymer films formed using such copolymers, and polymer film capacitors. The copolymers allow improved temperature stability, a high dielectric constant, a greatly reduced dielectric loss tangent (tan δ), higher charge-discharge efficiency, and greatly reduced leakage current. High energy density polymer capacitors using dielectric copolymer films comprising tetrafluoroethylene (TFE) have high temperature stability, low tan δ and high electric resistivity. The polar fluorovinyl components allow these excellent electrical properties to be combined with a high dielectric constant. Optional additional bulky fluorovinyl components may be included in the copolymer for flexibility and melt processing capability.

These film capacitors can be used in a broad range of pulsed power systems and power electronics including medical defibrillators, power management electronics in solar and wind energy, inverters in electric vehicles, and dielectrics in microelectronics for storing, controlling, and manipulation of electric charge, electric energy, and electric power with high efficiency.

Accordingly, examples of the present invention include capacitors having a dielectric layer comprising polar fluoropolymers with high dielectric constant, low dielectric loss tangent in a broad temperature range. New dielectric compositions combine the high dielectric constant of e.g. PVDF with the high temperature and low tan δ of e.g. PTFE. The capacitors can be used as DC bus capacitors in power inverters in electric vehicles and other electrical systems. The capacitors can also be used in pulsed power systems in which the capacitors deliver extremely high power density in milliseconds to nanoseconds scale.

Dielectric films according to examples of the present invention allow high energy efficiency, and the dielectric material can have low dielectric loss tangent (tan δ) and low leakage current (high electric resistivity) at the operation voltage, temperature, and frequency.

Since the dielectric films and the capacitor devices have the desirable dielectric and thermal performance, they also have large electrocaloric effect (ECE), as described for other ferroelectric polymers in Neese et al., “Large Electrocaloric Effect in Ferroelectric Polymers Near Room Temperature,” Science, 321, 821-823 (2008). ECE is the electric field-induced change in the entropy and temperature in a dielectric material. Therefore, examples of the present invention include an active module for cooling or a heat pump including dielectric films and capacitor devices described in this application.

For a typical parallel plate capacitor, the capacitance C is given by C=K∈₀ A/t where K is the dielectric constant (relative permittivity) of the dielectric layer, A is the area, t is the thickness of the dielectric layer, and ∈₀ is a constant (vacuum permittivity, 8.85×10⁻¹² F/m). This equation suggests that dielectric materials with higher K are desirable to provide higher capacitance.

The dielectric loss tangent tan δ of a dielectric material is defined as tan δ=K″/K′, where K″ and K′ are the imaginary and real dielectric permittivity, respectively. Tan δ is related to the electric energy that lost during the operation of the capacitors. The value of tan δ may change with frequency and temperature. It is desirable that capacitors have low tan δ in a wide temperature and frequency range.

Dielectric materials that can be made into thin dielectric layer with smaller t using inexpensive fabrication process are also beneficial to economically achieve higher capacitance in a small size.

For linear dielectric materials, the electric energy density that can be stored into the capacitor varies according to U=½K∈₀E², where E is the electric field applied upon the dielectric layer. This equation suggests that higher values of K are desirable for higher electrical energy density, which seems to suggest that tetrafluoroethylene would be a poor choice of monomer component for a copolymer based polymer film capacitor. However, in examples of the present invention, dielectric materials with both high K and high E are used to allow high energy densities to be obtained. In other words, capacitors according to the present invention can be made smaller in size than other capacitors that have lower K and lower operating electric field E, and even some capacitors having higher K, if E is lower.

The low leakage current at operation electric field and temperature allows capacitors to be fabricated having improved reliability, compared with conventional polymer film capacitors. The leakage current is inversely proportional to the electric volume resistivity.

Low dielectric loss tan δ and low leakage current at operating voltage, temperature, and frequency greatly improve the capacitors, not only because they are related to energy loss during operation, but also because that the lost electrical energy is usually converted into thermal energy, which leads to dramatic increase in capacitor temperature and capacitor failure.

Commercial electric devices require compact capacitor components which can be operated at least between −55° C. and 85° C. with high dielectric constant, low dielectric loss, and low leakage current. More advanced applications such as DC bus capacitors in the power inverters in hybrid electric vehicles (HEV) demand capacitors that can be operated at higher temperatures. For example, future power inverters in HEV may be continuously operated at or above 125° C. The high temperature stability of the capacitor component will permit the inverter operating at higher frequencies to achieve higher power and energy density, which will reduce the capacitance requirement and cost for the same power output. The high temperature capacitors can also be cooled with vehicle engine coolants, rather than additional low-temperature coolant. Therefore, capacitors with high temperature stability can minimize the cooling requirement and reduce the electric system cost.

In current electric vehicles such as hybrid electric vehicles (HEV) and plug-in electric vehicles (PEV), the electric drivetrain is a critical and expensive component in both designs. The electric drivetrain utilizes power inverter to manage the electric power stored in batteries or fuel cells to drive the electric motors. DC bus capacitors are one of the sub-components in the power inverter which serve as an energy source to stabilize DC bus voltage. As surveyed by the US Department of Energy, DC bus capacitors occupy ˜35% of the inverter volume, contribute to ˜23% of the weight, and add ˜25% of the cost [“Electrical and Electronics Technical Team Roadmap”, Department of Energy and the FreedomCAR Fuel Partnership, November 2006]. The specifications for the DC bus capacitors in electric vehicles include operation temperature above 125° C., leakage current below 2 mA, and dielectric loss tangent below 2%.

U.S. Pat. No. 4,543,294 disclosed a copolymer of tetrafluoroethylene, ethylene, and vinylidene fluoride with dielectric constant of 4.0 and above and dielectric loss tangent of 0.8% at 25° C. However, the tan δ increases dramatically at high temperature and it becomes higher than 1.5% at 50° C. Although tan δ at high temperature was not disclosed, it increases from ˜0.7% at 30° C. to ˜1.5% at 50° C. Extrapolating this trend it is expected that tan δ will be higher than 3.5% at 100° C., and higher than 4.5% at 125° C. The high tan δ at high temperature is not suitable for high temperature capacitor application such as DC bus capacitor in electric vehicles.

Copolymer dielectric films according to the present invention are the first dielectric films allowing such electric vehicle specifications to be met.

For commercial applications, it is also desirable that the capacitor film can be produced using melt extrusion and biaxial orientation process with low cost. Solvent-based film production will generate large amount of organic solvent waste, which not only creates environmental issues, but also significantly increases the film cost.

Furthermore, the capacitance density of a capacitor is inversely proportional with the square of the film thickness. Most polymer capacitor films such as PP, PPS, PVDF, and polyimide can be used at electric field from 100 MV/m to 600 MV/m (1 MV/m=1 V/micrometer=1 V/μm=10⁶ V/m), and most power electronics and pulsed power systems require capacitors with 500 V to 5,000 V voltage rating. For example, the DC bus capacitors in most HEV are operated at 400-600 V and the current PP capacitor film is approximately 3 μm or less. Capacitors in implantable and external defibrillators are operated at 800 V and 2,000 V, respectively. Therefore, the capacitor film preferably has a film thickness below 5 micrometers (μm), or more preferably below 2 μm to fully utilize the film potential and to achieve high capacitance density at relatively low operating voltage.

PVDF and related copolymers have been known for decades with high dielectric constant and high dielectric breakdown strength due to the strong C—F dipoles which are orientated in non-opposing directions.

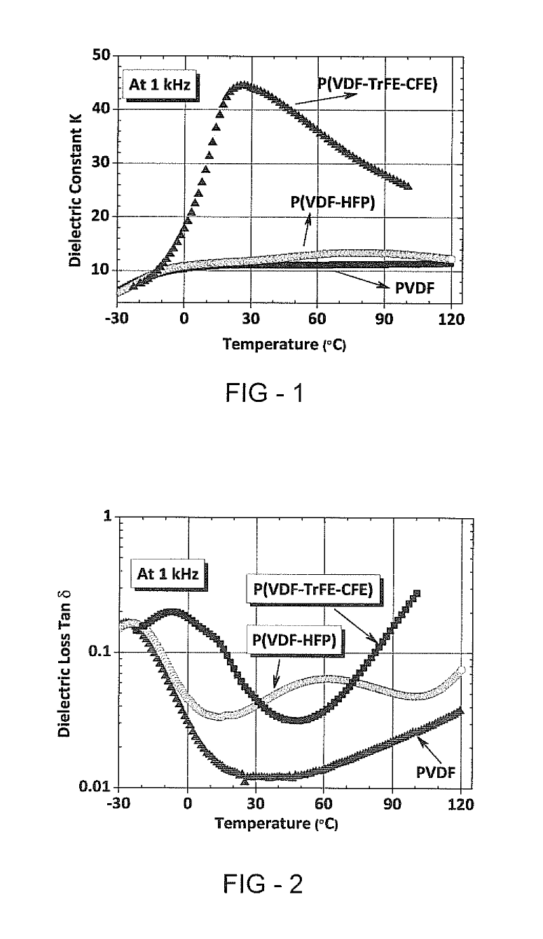

FIG. 1 shows the dielectric constant as a function of temperature at 1 kHz for PVDF, P(VDF-HFP), and P(VDF-TrFE-CFE) wherein CFE stands for 1-chloro-1-fluoroethylene. The dielectric constant was measured using an Agilent 4284A impendence analyzer at 1 kHz. All three polymers have high K. PVDF and P(VDF-HFP) have K above 10 at temperatures from 0° C. to 120° C., and P(VDF-TrFE-CFE) has K above 20 from 0° C. to 90° C. However, their K is low at temperatures below 0° C.

FIG. 2 shows the dielectric tan δ as a function of temperature at 1 kHz for PVDF, P(VDF-HFP), and P(VDF-TrFE-CFE). All three polymers have high tan δ. Although PVDF has tan δ of 1.3% at 25° C., it increases to 4% at 120° C. P(VDF-HFP) and P(VDF-TrFE-CFE) have tan δ well above 5% at temperatures above 80° C. Furthermore, all three polymers have tan δ above 10% at temperatures below −15° C. As to be presented later, they also have high leakage current at high temperatures.

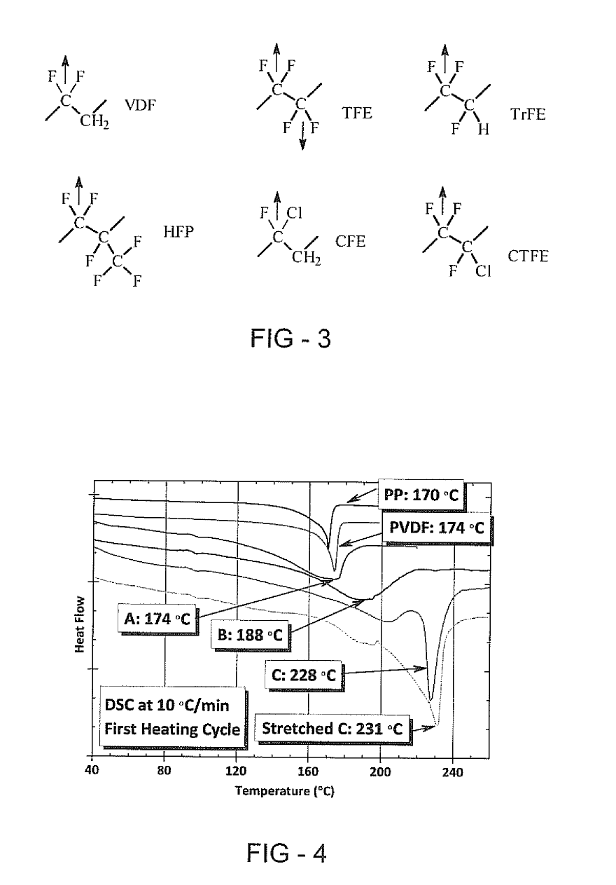

PTFE has high temperature stability and low dielectric tan δ due to the unique structure of tetrafluoroethylene. As schematically illustrated in FIG. 3, the C—F dipoles in TFE cancel each other since the C—F bonds in neighboring carbons are pointed to opposite directions due to steric constraint. In fact, despite the high dipole moment of CF₂ (>2 Debye), the dipole moment of TFE is almost 0 in PTFE. This leads to a low dielectric constant of only 2.0 in a broad temperature range, although the dielectric tan δ is well below 0.1%.

In addition to the low K, another disadvantage of PTFE is its poor capability for film production. Producing final articles using melt-based processes allows mass manufacturing due to the associated low cost. However, PTFE cannot be extruded in melt since it will chemically decompose at the processing temperature. PTFE film is usually produced using a skiving process, which continuously “peels” film from a cylindrical mold PTFE rod, similar to the wood veneer process [Jiri George Drobny, “Technology of Fluoropolymers”, second edition, CRC Press, 2009, page 65]. This process usually produces PTFE film or sheet with thickness from 25 μm to 3 mm, and it cannot be used to produce PTFE film with thickness below 5 μm and with high thickness uniformity. Therefore, although PTFE has been used as the dielectric layer in capacitors, the PTFE capacitors are generally much larger in size than those made from PP or PET, which have higher K and can be produced into high quality thin film with thickness below 3 micrometers.

In order to achieve melt-based processing capability, several approaches have been developed. In general, additional monomers have been introduced into PTFE during the polymerization process to form copolymers. Such monomers include ethylene (ETFE), hexafluoropropylene (FEP), and perfluorovinyl ether (such as DuPont Teflon® FPA, Solvay Solexis Hyflon® FPA and MPA). These co-monomers can decrease the melting temperature of PTFE so that they can be melt processed. However, these co-monomers are nonpolar with the C—F dipoles canceling each other. Therefore, their dielectric constant is still well below 3.0 (Table I).

In light of the above discussion, in order to combine the high temperature stability, high dielectric constant, low dielectric tan δ, high electric resistivity and the melt processing capability in a capacitor film, dielectric copolymers are described that synergistically combine the advantageous properties of at least two different components, and preferably at least three different components.

The first component contributes to the high temperature stability, low dielectric tan δ, and high electric resistivity. Tetrafluoroethylene TFE is a preferred first component. TFE has a dipole moment of almost 0 in PTFE.

A first component may be TFE, or comprise TFE and/or other monomers having a dipole moment less than 0.3, such as a dipole moment of essentially zero. In other examples the first component may be (or include) chlorotrifluoroethylene, tetrachloroethylene, and the like. In examples of the present invention, the copolymer includes at least 50% by weight of the first component, for example at least 60% by weight of the first component, for example at least 65% by weight of the first component, and in some examples at least 70% of the first component.

The second component preferably includes monomer(s) having a high dipole moment and a high dielectric constant. VDF (dipole moment of 2.1 Debye), TrFE, vinyl fluoride (VF), and 1-chloro-1-fluoroethylene (CFE) are examples. The dipole moment of a second component is preferably higher than 1.0 Debye. The large dipole moment allows a high K to be achieved. For example, ethylene has dipole moment much lower than 1.0 Debye, and the copolymer ETFE has low K of only 2.6.

The third optional component preferably has a bulkier size than VDF and destroys the regularity of the crystalline phase, therefore reduce the melting temperature for melt processing capability. A third component can also be introduced to increase the flexibility so that the film can be wound into a cylindrical capacitor. Example third components include CFE, HFP, CTFE, halogenated vinyl monomers including at least one chlorine and/or bromine atom, and perfluorovinyl ethers.

It should be pointed out that the term “copolymer” is used with a broad meaning which includes polymers with two different monomers, three different monomers (terpolymer), four different monomers (quadpolymer), or more than four different monomers.

It should be further pointed out that the second component can be one monomer or more than one monomer, as long as they have dipole moment above 1.0 Debye.

The term “component” may refer to one or more monomers used to form the copolymer. For example, a given component may include monomers defined by structural and/or chemical and/or physical properties. For example, the first component may include one or monomers having essentially zero dipole moment, or a dipole moment less than 0.3. Alternatively, the first component may be structurally defined as TFE, or one or more monomers, such as an unhalogenated or perhalogenated monomer, such as an unhalogenated or tetrahalogenated ethylene. The second component may comprise one or more monomers selected from the group consisting of CFE, HFP, CTFE, vinyl monomers containing chloride or bromide, and perfluorovinyl ethers. The second component may comprise monomers having a dipole moment greater than 1 D. The second component may comprise one or more partially halogenated monomers, such as partially halogenated ethylenes.

It should be further pointed out that the third component can be one monomer or more than one monomer, as long as they have molecular size larger than VDF.

Examples of the copolymers for the capacitors or other devices include P(TFE-VDF), P(TFE-TrFE), P(TFE-CFE), P(TFE-VDF-HFP), P(TFE-VDF-CTFE), P(TFE-TrFE-HFP), PTFE-TrFE-CTFE), P(TFE-VDF-CFE), P(TFE-VDF-perfluorovinyl methyl ether), P(TFE-VDF-perfluorovinyl propyl ether), P(TFE-VDF-HFP-perfluorovinyl methyl ether), P(TFE-VDF-HFP-perfluorovinyl propyl ether).

In order to balance the dielectric properties, the compositions of the copolymers are preferably controlled in such a way that the K>4.0, tan δ<2%, and melting temperature (Tm) higher than 160° C. can be obtained.

The content of the first component, such as TFE, can be high (for example greater than 50% by weight) to give a copolymer having high Tm and low tan δ. However, TFE would not appear to be a promising component to obtain a high energy density capacitor, as TFE is non-polar. An increasing content of TFE will reduce the dielectric constant of the copolymer.

In examples of the present invention, the weight content of TFE (or other first component) in the copolymer is preferably from 50% to 90%, more preferably from 60% to 80%, and more preferably from 65% to 80%. Copolymers with TFE over 90% by weight will have low K.

The content of the second component can also be controlled. High content will lead to high dielectric constant and high tan δ. Its weight content is preferably from 5% to 40%, more preferably from 10% to 30%, and more preferably from 10% to 15%

The content of additional optional components, such as a third component, is preferably below 20% by weight. High content will lead low melting temperature, low thermal stability, and low dielectric breakdown strength.

In one embodiment, VDF is used as the second component and hexafluoropropylene (HFP) is used as the third component. The preparation of the P(TFE-VDF-HFP) has been disclosed in U.S. Pat. No. 4,696,989. In the P(TFE-VDF-HFP) copolymers. The content of the TFE is preferable higher than 65% by weight.

In another embodiment, VDF is used as the second component. HFP and perfluorovinyl ether or CTFE are used at the third component. The additional perfluorovinyl ether further improves the flexibility. Such copolymers can be prepared using approaches similar to those disclosed in U.S. Pat. Nos. 6,610,807, 6,489,420, and 6,884,860.

In yet another embodiment, P(TFE-VDF) copolymers can be used as the capacitor dielectric layer.

Copolymers of such components are strongly preferred for capacitor applications. Polymer blends with homopolymers of individual components have multiple melting temperatures, and the highest operational temperature of the capacitor is determined by the homopolymer with the lowest melting temperature.

The copolymers can be processed into a thin capacitor film using solvent casting, dip coating, spin coating, screen printing, and melt extrusion. When melt extrusion is used, the extruded copolymer sheet can be further blown into a tube with certain degree of chain orientation and thinner thickness. The extruded sheet can also be stretched in either one direction or two directions to achieve higher mechanical strength and thinner thickness.

The copolymers can also be crosslinked by using irradiation, free radical initiators, or ionic crosslinking chemistry. Crosslinking will further increase the thermal stability of the capacitor film.

Organic and/or inorganic fillers can be added into the capacitor film. These fillers may further increase the dielectric constant of the capacitor film. These fillers can also control the surface roughness of the capacitor film for high speed film winding, metallization, and capacitor winding. Example fillers include polymer fillers, ceramic fillers, and the like. Other additional non-polymer components can be included, for example to assist processing. Dielectric films may also comprise a copolymer as described herein blended with another polymer or copolymer, or as a multilayer film with another polymer or copolymer.

The copolymer capacitor film can also be coated with additional layers of material to improve the interface adhesion between the film and the metal electrode. A metal electrode may have a multilayer structure.

The thickness of the capacitor film is determined by the capacitor operation voltage. Example capacitor films have thickness below 25 μm, preferably below 15 μm, more preferably below 10 μm, and more preferably below 5 μm. Example polymer film thickness ranges include 0.1-25 μm, such as 0.1-15 μm, 0.1-10 μm, and 0.1-5 μm.

An example capacitor includes alternating layers of a copolymer dielectric layer and an electrically conductive layer.

In some embodiments, an electrically conductive layer is deposited on a copolymer capacitor film. Examples of electrode materials include aluminum, zinc, iron, silver, gold, platinum, alloys, other metals, and conducting polymers.

In other embodiments, a metal foil can be used as the electrode layer. In yet another embodiment, metallized film can be used as the electrode layer.

The capacitor can be a wound capacitor, a stacked multilayer capacitor, or an electrode-insulator-electrode device.

Test Protocols

A TA DSC 100 was used to measure the melting temperature. 5-10 mg of capacitor film was used for the measurement. The melting temperature Tm is defined as the peak temperature in the first heating cycle at 10° C./min.

For the electrodes, 30 nm-thick gold was sputtered onto both of the capacitor film surfaces as the electrode using an Emitech K550X sputtering machine. The diameter of the metallized area is 6 mm.

Dielectric properties were measured with an Agilent 4284A impedance analyzer at heating rate of 2° C. The thickness of the capacitor film was between 50 μm and 100 μm.

For the dielectric breakdown strength, the metallized capacitor film was soaked in silicone dielectric fluid with controlled temperature. DC voltage was applied at a rate of 500 V/second. The thickness of the capacitor film for dielectric breakdown test is usually between 5 μm and 20 μm. The dielectric breakdown strength was calculated using Weibull statistic analysis:

$${P}_{f} = 1 - exp [ - {( \frac{E}{{E}_{b}} )}^{β} ]$$

where E is the measured breakdown electric strength. β is the shape parameter and a larger β is preferred since it corresponds to a narrower breakdown strength distribution. E_{b} is the Weibull breakdown strength (63.2% of accumulated probability for breakdown). The unit of the dielectric breakdown strength is MV/m, which is equivalent to 10⁶ V/m.

The delivered electrical energy density (UE) of the capacitor was directly measured with a modified Sawyer-Tower circuit. The reported UE represents the energy that the capacitor can effectively deliver to the external load. It was calculated using U_{E}=∫EdD, when the voltage is reduced from peak value to zero volt.

The charge-discharge efficiency (η) is defined as the ratio of the electric energy that the capacitor can deliver to the load to the electric energy that is charged into the capacitor. The charged energy density is also calculated using U_{E}=∫EdD during the charging process.

Electric volume resistivity was measured using a Trek 610 (Trek, Inc., Medina, New York) and a Keithley 6485 Picometer (Keithley Instruments, Inc., Cleveland, Ohio). The metallized capacitor film has diameter of 10 mm and was soaked silicone fluid with controlled temperature. The measurement was performed under 100 MV/m and the current was read after stabilizing for 360 seconds.

### Example 1

### Comparative

Commercial polypropylene capacitor film with thickness of 4.8 microns was purchased from Steinerfilm, Inc. (Williamstown, Mass.). The film performance was tested following the above protocols.

### Example 2

### Comparative

A PVDF capacitor film with thickness of 8 micrometers was produced by stretching extruded PVDF sheet in two directions.

### Example 3

### Comparative

P(VDF-TrFE-CFE) copolymer was prepared by suspension polymerization. The powder was dissolved in DMF, filtered with 1 μm filter, and then cast on glass slides to obtain film with thickness from 10 μm to 15 μm.

### Example 4

### Copolymer A

P(TFE-VDF-HFP) with composition of 59 wt % TFE, 22 wt % of VDF, and 19 wt % of HFP was used. The copolymer pellets were fed into a Brabender single screw extruder with diameter of ¾ inch and equipped with a metering pump and a blown film die. The temperatures of the extruder, metering pump, and the die were set at 270° C., 260° C., and 260° C., respectively. A tube with diameter of ½ inch was obtained after the die, and it was blown into a bubble with diameter over 3 inches. The blown film has thickness of 10 micrometers to 50 micrometers.

### Example 5

### Copolymer B

P(TFE-VDF-HFP) with composition of 67.5 wt % TFE, 17.5 wt % of VDF, and 15 wt % of HFP was used. The copolymer pellets were fed into a Brabender single screw extruder with diameter of ¾ inch and equipped with a metering pump and a blown film die. The temperatures of the extruder, metering pump, and the die were set at 270° C., 230° C., and 230° C., respectively. A tube with diameter of ½ inch was obtained after the die, and it was blown into a bubble with diameter over 3 inches. The blown film has thickness of 10 micrometers to 50 micrometers.

### Example 6

### Copolymer C

P(TFE-VDF-HFP) with composition of 76.1 wt % TFE, 13 wt % of VDF, and 10.9 wt % of HFP was used. The copolymer pellets were fed into a Brabender single screw extruder with diameter of ¾ inch and equipped with a metering pump and a blown film die. The temperatures of the extruder, metering pump, and the die were set at 285° C., 260° C., and 260° C., respectively. A tube with diameter of ½ inch was obtained after the die, and it was blown into a bubble with diameter over 3 inches. The blown film has thickness of 10 micrometers to 50 micrometers.

### Example 7

### Uniaxially Stretched Copolymer C

The blown film of copolymer C prepared in example 6 with thickness ˜40 micrometers was stretched in the direction perpendicular to the winding direction to a length that is 600%-800% of its original length (6×−8× stretching). The stretched film has thickness of approximately 10 micrometers.

### Example 8

### Biaxially Stretched Copolymer C

The blown film of copolymer C prepared in example 6 with thickness ˜40 micrometers was stretched in the direction perpendicular to the winding direction to a length that is 600% of its original length (6× stretching). The uniaxially stretched film was then stretched in the other direction for 1.5-times to obtain biaxially orientated film C with thickness approximately 10 micrometers.

### Example 9

### Uniaxially Stretched Copolymer A

Similar to example 7, blown film A was also stretched by 6×−8× to obtain stretched film A with thickness of ˜10 micrometers.

### Example 10

### Uniaxially Stretched Copolymer B

Similar to example 7, blown film B was also stretched by 6×−8× to obtain stretched film B with thickness of ˜10 micrometers.

### Example 11

### Polarization Charge Density Comparison

The film samples were metallized with a gold electrode and the charge density was measured at 500 MV/m for PP, PVDF, and P(TFE-VDF-HFP)

### Example 12

### Film Stretching Test

P(TFE-VDF-HFP) Composition C was extruded using the small extruder and 100 μm thick film was obtained. The film was cut into Instron specimens with dimension of 5 mm wide, 22.5 mm long, and ˜100 μm thick. The stress was recorded when the specimen was stretched at 25.4 mm/min. The test was performed at both extruder machine direction (MD) and transverse direction (TD).

TABLE II
Young's Modulus (MPa) of P(TFE-VDF-HFP) Composition C.

| Specimen | MD | TD |
|---|---|---|
| #1 | 480 | 466 |
| #2 | 469 | 482 |
| #3 | 463 | 492 |
| #4 | 440 | 499 |
| #5 | 463 | 491 |
| Average | 463 | 486 |
| Standard | 14.6 | 12.7 |
| Deviation | | |

The extruded P(TFE-VDF-HFP) composition C film has a modulus higher than 400 MPa at room temperature. A higher modulus is obtained after orientation, as known in the plastic film industry.

FIG. 4 presents the second heating DSC curves of the capacitor films. It can be seen that the melting temperatures of PP, PVDF, copolymer A, B, and C are 170° C., 174° C., 174° C., 188° C., and 228° C., respectively. P(TFE-VDF-HFP) copolymer C has significantly higher Tin than other polymers. Higher Tₘ is desirable for high temperature operation of the film capacitor. PP has Tin of 170° C. and its operation is usually limited to below 105° C. The copolymer C has much higher TFE content, which leads to higher Tₘ. However, the 49° C. increase in Tₘ from sample B to sample C is surprisingly high considering that the TFE content is only increased by 9.6%. Furthermore, stretched capacitor film C has a melting temperature of 231° C., which is 61° C. higher than PP.

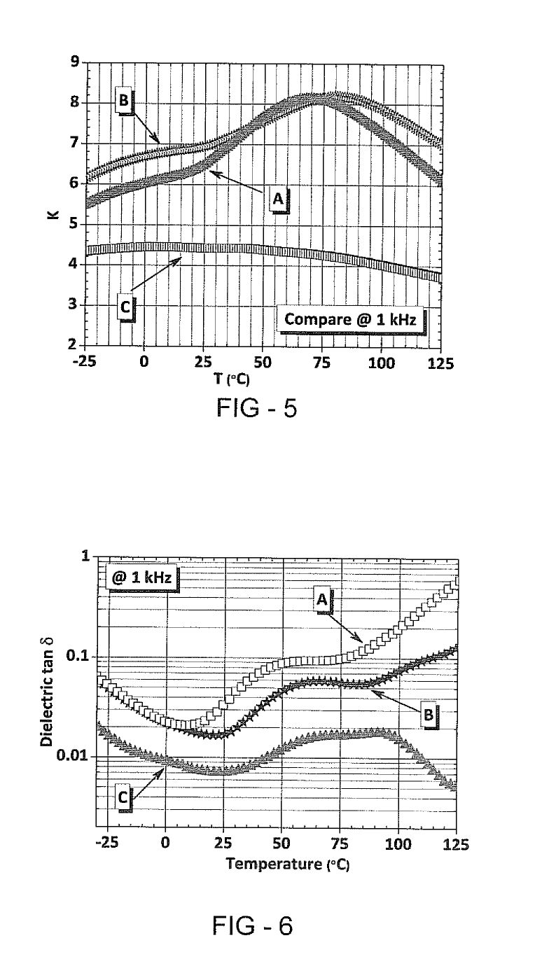

FIG. 5 compares the dielectric constant of copolymers A, B, and C at 1 kHz. Samples A and B have high K above 5.0 at temperatures from −25° C. to 125° C. However, similar to PVDF, the dielectric constant of A and B varies with temperature and they reach maximal at 70-100° C. Sample C has K above 4.4 from 0° C. to 85° C., and above 3.7 from −30° C. to 125° C. Furthermore, K of sample C is relatively stable in the broad temperature range, which is important for DC bus capacitor application. P(TFE-VDF-HFP) copolymer C has higher nonpolar TFE content than A and B, therefore its K is lower than A, B and PVDF. The dielectric constant K of sample C is approximately 100% higher than that of PP, and 30% higher than that of PET, PPS, PEN, and polyimide.

FIG. 6 compares the dielectric loss tan δ of blown films A, B, and C at 1 kHz. At 25° C., tan δ of A, B, and C is 3.35%, 1.72%, and 0.72% respectively. The dielectric tan δ of sample A and B has similar dependence on temperature as PVDF. Tan δ of sample C is significantly lower than that of the other two, it is lower than 2% from −30° C. to 125° C., it decreases with increasing temperature at 100-125° C. with tan δ=0.52% at 125° C. The low tan δ at high temperature is very important for high temperature applications. The low dielectric tan δ of P(TFE-VDF-HFP) copolymer C is a result of its higher content of nonpolar TFE than that of copolymers A and B and homopolymer PVDF.

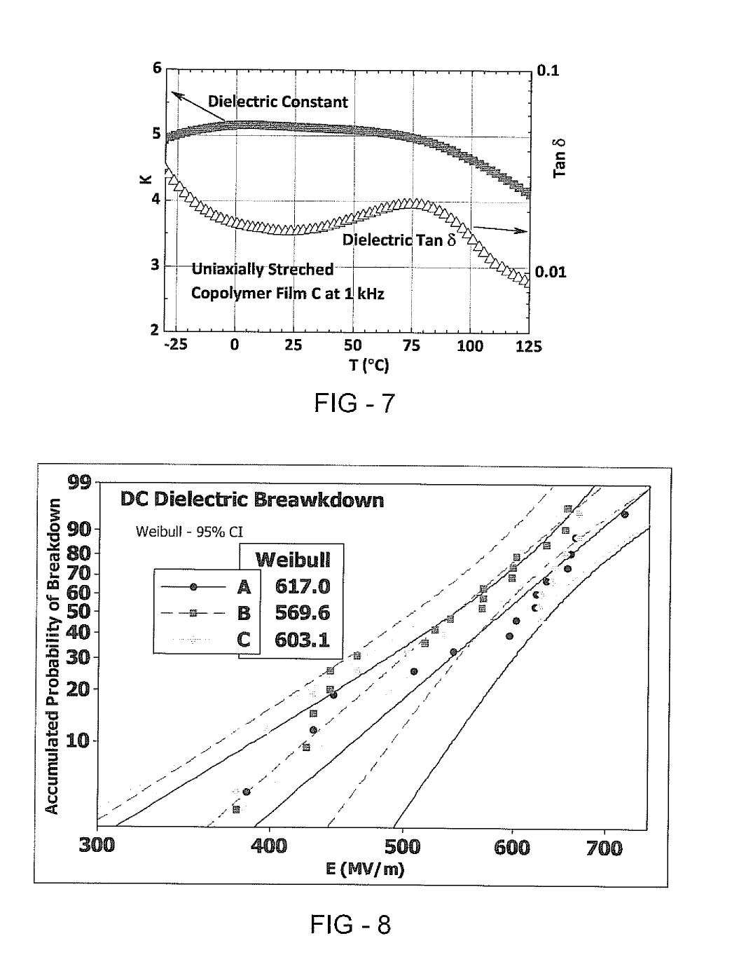

FIG. 7 shows the dielectric constant and tan δ of uniaxially stretched film C. It is surprising to see that the stretched film has K above 5.0 from −25° C. to 75° C., which is over 13% higher than the blown film with the same composition and 127% higher than PP. At 125° C., K decreases to 4.2. The dielectric tan δ of the stretched film C has similar temperature dependence as that of the blown film, but the former is slightly higher than the latter.

FIG. 8 compares the DC dielectric breakdown strength of uniaxially copolymers A, B, C at 26° C. and 16% relative humidity. The test film specimens have thickness about 10 μm and coated with 30 nm thick gold on an area of 0.28 cm² (6 mm diameter). The Weibull dielectric breakdown strengths of copolymer A, B, and C are 617.0 MV/m, 569.6 MV/m, and 603.1 MV/m, respectively. These values are statistically similar and are also comparable to the dielectric breakdown strength of PP and PVDF (Maurizio Rabuffi and Guido Picci, “Status Quo and Future Prospects for Metallized Polypropylene Energy Storage Capacitors”, IEEE TRANSACTIONS ON PLASMA SCIENCE, VOL. 30, NO. 5, OCTOBER 2002, page 1939).

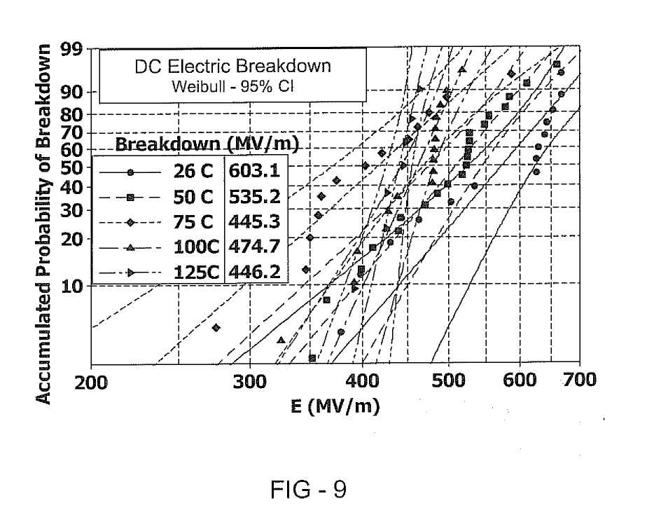

FIG. 9 compares the DC dielectric breakdown strength of uniaxially stretched copolymer film C at different temperatures. The DC dielectric breakdown strengths are 603.1 MV/m at 26° C., 535.2 MV/m at 50° C., 445.3 MV/m at 75° C., 474.7 MV/m at 100° C., and 446.2 MV/m at 125° C. There is initial decrease in breakdown strength from 26° C. to 50° C. to 75° C., and it remains almost constant at 75° C. to 125° C. Dielectric breakdown strength of 446.2 MV/m is still high for DC bus capacitor applications, which are usually operated at 200 MV/m.

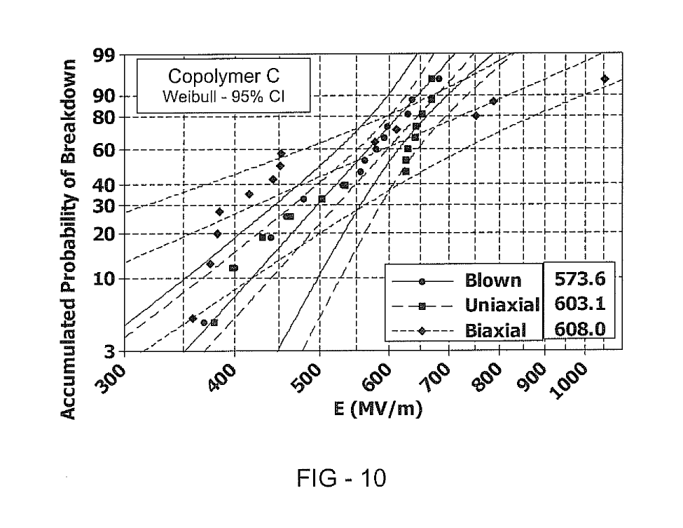

FIG. 10 shows the DC dielectric breakdown strength of blown film, uniaxially, and biaxially orientated copolymer film C at room temperature. The blown film with thickness of ˜10 micrometers has dielectric breakdown strength of 573.6 MV/m, it increases to 603.1 MV/m for the uniaxially stretched capacitor film, and 608.0 MV/m for the biaxially stretched capacitor film. It is known that orientation can improve the film mechanical strength and dielectric breakdown strength in PP and PVDF.

The high DC dielectric breakdown strength of the P(TFE-VDF-HFP) copolymers is related to their semicrystalline structure and their high mechanical strength. Copolymer C has high Tm, therefore, it still maintains reasonably high dielectric breakdown strength even at 125° C.

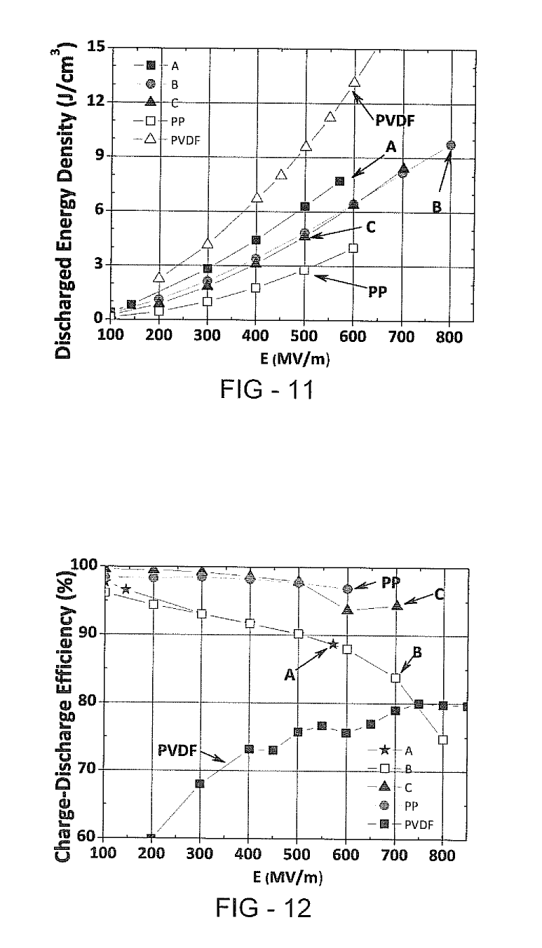

The discharged energy density of the uniaxially stretched capacitor films A, B, C, PVDF, and PP is summarized in FIG. 11. While the highest test electric field may be determined by individual film sample quality, at 400 MV/m, the discharged energy density of PP and PVDF is 1.8 J/cm³ and 6.7 J/cm³, respectively. P(TFE-VDF-HFP) copolymer A, B, and C have energy density of 4.4, 3.4, and 3.1 J/cm³, respectively at the same electric field. Copolymer C has more nonpolar TFE and lower K, therefore, its energy density is lower than A, B, and PVDF. However, the discharged energy density of copolymer C is still significantly higher than PP at the same electric field, consistent with the dielectric constant.

FIG. 12 compares the charge-discharge efficiency of different capacitor films at 400 MV/m and 25° C. Although PVDF has the highest energy density, its efficiency is only 73.2%. On the other hand, commercial PP capacitor film has the lowest energy density, but with the highest efficiency of 98.2%. Consistent with their low dielectric tan δ at low electric field, the charge˜discharge efficiency of P(TFE-VDF-HFP) copolymer A, B, and C is 91.7%, 91.7%, and 98.6%, respectively. Again, copolymer C has higher efficiency than B and A due to its higher content of nonpolar TFE unit. While the dielectric tan δ at low electric field reflects the energy loss associated with dipole reorientation, the energy loss at high electric field is related to charge injection from electrode and leakage current. It should be pointed out that although the dielectric tan δ of P(TFE-VDF-HFP) copolymer C is about 50-time higher than PP at low electric field, the charge-discharge efficiency of the former is similar to that of PP at 400 MV/m. This may be related to the strong C—F dipoles in P(TFE-VDF-HFP) which may act as traps for injected charges. The low charge-discharge efficiency in PVDF is associated with its ferroelectric loss and high leakage current. The high charge-discharge efficiency is important for high temperature application. Low efficiency will not only lead to energy loss during operation, but also cause thermal runaway and failure of the capacitor.

While copolymer C has better thermal stability and higher efficiency than copolymers A and B, the latter two copolymers are still useful for certain capacitor applications such as medical defibrillators. Current electrolytic capacitors in implantable cardiovascular defibrillators (ICD) have energy density of 4 J/cm³ and efficiency of about 75%. Copolymers A and B have similar energy density as the ICD capacitors, but with much higher efficiency. Such ICD capacitors are usually only used at 37° C.

The energy loss during the capacitor operation includes contributions from dielectric loss tan δ, resistance from the electrode, ferroelectric loss, and leakage current. Particularly, the energy loss is usually much higher than that expected from tan δ alone at high electric field (>100 MV/m), suggesting that the leakage current may be the dominating factor (Qin Chen, et al, “High field tunneling as a limiting factor of maximum energy density in dielectric energy storage capacitors”, Applied Physics Letters, 2008, 92, 142909). Therefore, it is desirable that a capacitor dielectric has low leakage current and high electric volumetric resistivity at operation electric field and temperature.

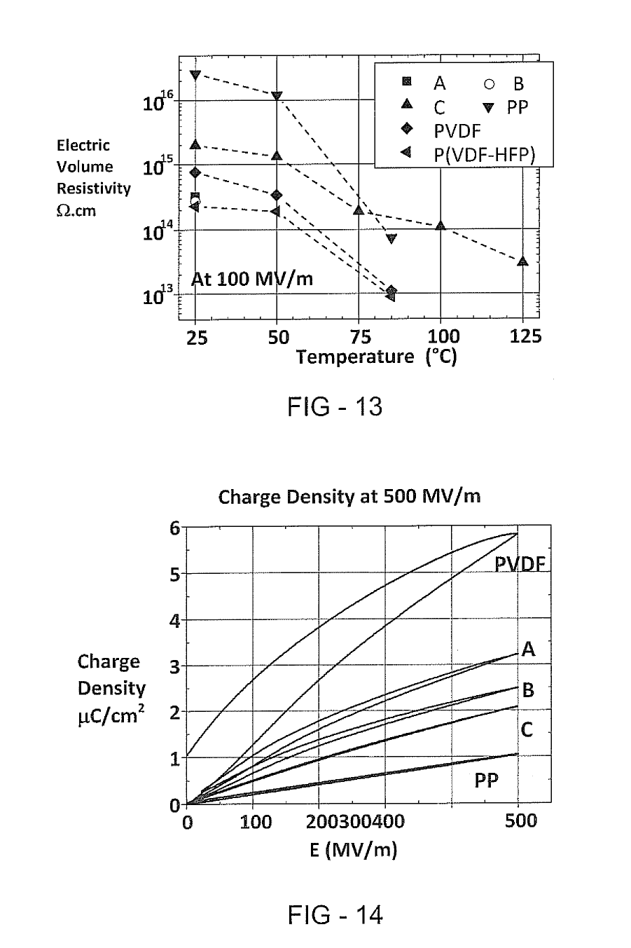

FIG. 13 compares the volume resistivity of P(TFE-VDF-HFP) copolymers, PP and PVDF at different temperatures measured at 100 MV/m. The electric resistivity is recorded after the voltage has been applied for 360 seconds. As a nonpolar polymer with extremely low dielectric tan δ and high crystallinity, PP has very high resistivity of 2.6×10¹⁶ Ω·cm at 25° C. However, it quickly decreases to 7.4×10¹³ Ω·cm at 85° C. since it becomes soft at high temperatures. PVDF has relatively high electric resistivity at 25° C. with a value of 7.6×10¹⁴ Ω·cm. It also reduces to 1.1×10¹³ Ω·cm at 85° C. since it has similar melting temperature as PP. The low resistivity of PVDF as compared with PP is a result of its polar structure from VDF. P(VDF-HFP) has lower electric resistivity than PVDF and PP since it has lower crystallinity. The volume resistivity of P(VDF-HFP) is 2.3×10¹⁴ Ω·cm and 8.9×10¹² Ω·cm at 25° C. and 85° C., respectively. The relatively low resistivity of PP, PVDF, and P(VDF-HFP) at 85° C. and continuous decrease at higher temperature are the primary reason that they cannot be used at above 105° C., or their operating voltages must be significantly de-rated at above 105° C.

Since P(TFE-VDF-FIFP) copolymers A and B have similar dielectric properties and melting temperature as PVDF, they have volume resistivity of ˜3×10¹⁴ Ω·cm at 25° C., which is similar to PVDF. The copolymer C has high content of nonpolar unit TFE, high melting temperature, and low dielectric tan δ, therefore it has high volume resistivity of 2.0×10¹⁵ Ω·cm at 25° C., which is higher than PVDF, P(VDF-HFP) and copolymers A and B. More importantly, at temperatures above 85° C., the P(TFE-VDF-HFP) copolymer C still has relatively high electric resistivity, and it is even higher than the nonpolar PP. For example, at 85° C., the copolymer C has resistivity of 1.5×10¹⁴ Ω·cm, which is at least 100% higher than PP. Even at 125° C., the copolymer C still has a resistivity of 3×10¹³ Ω·cm.

While the improvement in dielectric constant, dielectric tan δ, electric resistivity, temperature stability, and charge-discharge efficiency is a direct consequence of the TFE component, it is unexpected that the TFE content is very high to achieve the improvement. For example, in copolymer C, the TFE content is as high as 76.1 wt %.

FIG. 14 compares the charge density at 500 MV/m for PP, PVDF, and P(TFE-VDF-HFP) compositions A, B, and C. The charge density is proportional to the dielectric constant and PVDF has the highest and PP has the lowest charge density. However, the energy lost in the charge-discharge process is also critical to continuous operation of the capacitor and in most applications, the electrical energy loss-induced temperature rise is the dominant factor for capacitor failure. It is highly desirable that the capacitor has low energy loss. The P(TFE-VDF-HFP) compositions have higher charge density than PP, but still with low energy loss. Particularly, the P(TFE-VDF-HFP) composition C has a charge density that is more than 100% higher than PP, but the charge-discharge efficiency is comparable to PP.

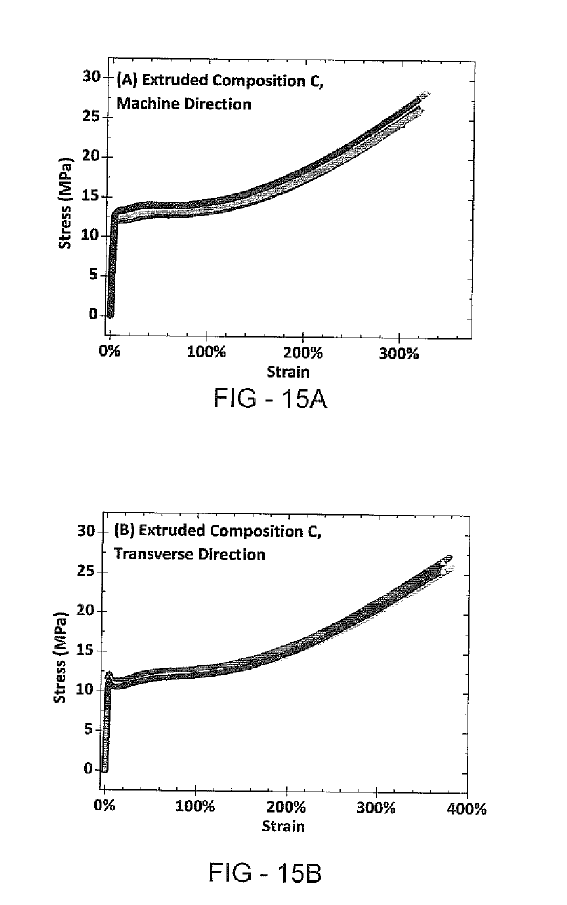

Orientation of the capacitor film is important for high dielectric breakdown, mechanical strength, and the production of thin film. FIGS. 15A-B show the stress-strain curves of the P(TFE-VDF-HFP) composition C in both machine direction and transverse direction, respectively. The film was prepared by melt extrusion using a sheet die. It can be seen in FIGS. 15A-B that the specimens can be stretched by more than 300% at room temperature. Table II (above) compares the Young's modulus of the composition C.

With the above discussion and examples, it is clear that high dielectric constant, low dielectric tan δ, high charge-discharge efficiency, and high electric volume resistivity can be obtained in copolymers comprising high-temperature nonpolar component (such as TFE), a second component with high dipole moment (such as VDF), and optionally third component of HFP. Preferably, the content of TFE is higher than 50% by weight, such as 60% by weight, or 65% by weight, and in some examples can be higher than 70% by weight.

For example, the weight content of the first component, such as TFE, can be 50% to 90%, such as 60% to 80%, and more particularly from 65% to 80%, and even more particularly from 70%-80%.

The high performance at temperatures above 85° C. is important for a variety of applications which require the operation of the capacitor at high temperature with high repetition rate. Capacitors comprising the P(TFE-VDF-HFP) copolymers are advantageous over PP, PVDF, and P(VDF-HFP) for high temperature applications.

All ranges given are inclusive. Examples of the present invention also include compositions approximately within any given ranges.

Examples of the present invention include polymers, dielectric films including polymers, and apparatus including such dielectric films, such as capacitors, electronic control devices such as field effect transistors, other charge storage and energy storage devices, defibrillators including such energy storage devices, electric vehicles, sensors, actuators, and the like.

Examples of the present invention also include cooling apparatus and heat pumps that use the electrocaloric effect of a dielectric film to provide a temperature change by applying and/or removing an electric field from the dielectric film.

Although the examples are focused on P(TFE-VDF-HFP) copolymers, the same performance can also be achieved in copolymers comprising similar structure components.

The present invention has been described with particular reference to the preferred embodiments. It should be understood that the descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A device for storing, and/or controlling, and/or manipulating charge and/or electric energy, the device having a dielectric layer,
the dielectric layer comprising a copolymer which includes a first component and a second component,
the first component being tetrafluoroethylene (TFE), the copolymer containing from 50% to 90% by weight of the first component,
the second component being one or more unsaturated fluorovinyl monomers each having a dipole moment larger than 1 Debye,
the copolymer containing from 10% to 50% by weight of the second component.

2. The device of claim 1, wherein the second component includes one or more monomers selected from the group consisting of vinylidene fluoride (VDF), trifluoroethylene (TrFE), 1-chloro-1-fluoroethylene (CFE), and vinyl fluoride.

3. The device of claim 1, wherein the copolymer has a dielectric constant above 4.0 at 1 kHz at temperatures from −25° C. to 85° C.

4. The device of claim 1, wherein the copolymer is a semicrystalline polymer and has a melting temperature above 160° C.

5. The device of claim 1, wherein the copolymer further includes a third component,
the third component including monomers that are bulkier than vinylidene fluoride,
the third component having the function to increase the flexibility and melt-processing capability of the copolymer,
the copolymer containing less than 20% by weight of the third component.

6. The device of claim 5, wherein the third component comprises hexafluoropropylene (HFP), chlorotrifluoroethylene (CTFE), or an unsaturated perfluorovinyl ether with formula of CF₂═CF—OR_{f} where R_{f} is a perfluoroalkyl of 1 to 8 carbon atoms, or some combination thereof.

7. The device of claim 1, wherein the copolymer is poly(tetrafluoroethylene-co-vinylidene fluoride-co-hexafluoropropylene), and
the tetrafluoroethylene content is from 65% to 90% by weight,
the VDF content is from 5% to 20% by weight, and
the HFP content is from 1% to 20% by weight.

8. The device of claim 7, wherein the melting temperature of the copolymer is above 160° C.

9. The device of claim 1, wherein the copolymer is poly(tetrafluoroethylene-co-vinylidene fluoride-co-hexafluoropropylene),
the tetrafluoroethylene content is between 70% to 80% by weight, and
the VDF content is from 5% to 20% by weight, and
the HFP content is from 1% to 20% by weight.

10. The device of claim 1, wherein the copolymer has a melting temperature above 200° C.

11. The device of claim 1, wherein the copolymer has a dielectric loss tangent (tan δ) lower than 2% at 1 kHz from −25° C. to 125° C.

12. The device of claim 1, wherein the copolymer has a volume resistivity above 10¹⁵ Ω·cm at 25° C. and above 10¹³ Ω·cm at 125° C.

13. The device of claim 1, wherein the copolymer has a charge density above 2 μC/cm² at 500 MV/m at 25° C., and has a charge-discharge efficiency above 90%.

14. The device of claim 1, wherein the copolymer is poly(tetrafluoroethylene-co-vinylidene fluoride-co-chlorotrifluoroethylene).

15. The device of claim 1, wherein the copolymer is poly(tetrafluoroethylene-co-vinylidene fluoride),
having a TFE content higher than 50% by weight.

16. The device of claim 15, wherein the TFE content is higher than 62% by weight

17. The device of claim 15, wherein the TFE content is higher than 70% by weight

18. The device of claim 1, wherein the copolymer is poly(tetrafluoroethylene-co-trifluoroethylene),
having a TFE content higher than 50% by weight.

19. The device of claim 1, wherein the copolymer is poly(tetrafluoroethylene-co-vinylidene fluoride-co-CF₂CF—O—CₙF₂ₙ₊₁), wherein n is an integer from 1 to 8 inclusive.

20. The device of claim 1, wherein the copolymer is poly(tetrafluoroethylene-co-vinylidene fluoride-co-hexafluoropropylene-co-2-propoxypropylvinyl ether).

21. The device of claim 1, wherein the copolymer is poly(tetrafluoroethylene-co-vinylidene fluoride-co-hexafluoropropylene-co-perfluoro-2-methoxy-ethylvinyl ether).

22. The device of claim 1, wherein the dielectric layer is a polymer film.

23. The device of claim 22, the polymer film being a solvent cast film, a melt extruded film, or a melt extrusion blown film.

24. The device of claim 22, wherein the polymer film is stretched in one direction or two directions, and has a stretching ratio from 100% to 900% of the original length in each direction.

25. The device of claim 22, wherein the polymer film is stretched in either one direction or two directions with a stretching ratio higher than 300% of the original length in each direction, and
the Young's modulus of the unstretched film is higher than 400 MPa.

26. The device of claim 1, wherein the copolymer is crosslinked to form a thermosetting material.

27. The device of claim 1, wherein the copolymer has a charge-discharge efficiency higher than 90% at 400 MV/m electric field.

28. The device of claim 1, wherein the copolymer further includes organic and/or inorganic fillers.

29. The device of claim 1, wherein the dielectric layer is coated with another material to form a multilayer structure.

30. The device of claim 1, wherein the copolymer has a DC dielectric breakdown strength above 500 MV/m at 25° C.

31. The device of claim 1, wherein the device is a polymer film capacitor.

32. The device of claim 31, wherein the polymer film capacitor includes one or more metallized dielectric layers, alternating dielectric layers and metal foils, or a hybrid metallized film and foil construction.

33. The device of claim 1, wherein the device is a field effect transistor, the dielectric layer being a gate dielectric film of the field effect transistor.

34. The device of claim 1, wherein the device is a capacitor for pulsed power applications.

35. The device of claim 1, wherein the device is a DC bus capacitor in a power inverter or converter.

36. The device in claim 1, wherein the device is used in a defibrillator.

37. The device of claim 1, wherein the device is operable above 105° C.

38. The device of claim 1, wherein the device is operable above 125° C.

39. A device comprising the dielectric layer of claim 1, wherein the device generates temperature and entropy change upon applying or removing electric field based on the electrocaloric effect,
the device being a cooling or heat pump.
